(19) United States
(12) Patent Application Publication
(10) Pub. No.: US 2013/0321669 A1
(43) Pub. Date: Dec. 5, 2013

(54) Hindsight Mirror Apparatus

(71) Applicant: James Wayne Youngs, (US)

(72) Inventor: James Wayne Youngs, Hampton, VA (US)

(21) Appl. No.: 13/867,423

(22) Filed: Apr. 22, 2013

Related U.S. Application Data
(60) Provisional application No. 61/652,720, filed on May 29, 2012.

(51) Int. Cl. H04N 5/232

(52) U.S. Cl. CPC H04N 5/23293; H04N 5/23296
USPC 348/240.99; 348/333.01

(57) ABSTRACT

A hindsight mirror apparatus that includes a mirror device that displays an image of an object thereon, a monitor unit coupled with the mirror device at a rear thereof and providing the image to the mirror device to be displayed, an image capturing device electrically connected with the monitor unit capturing the image to be displayed. The image to be displayed is at least a rear view of the object. A control mechanism is provided to control the image capturing device, the mirror device and the monitor unit, to capture and display the image and supplies power to the hindsight mirror apparatus.

### CROSS-REFERENCE

The present invention claims priority to Provisional Application Ser. No. 61/652,720 filed May 29, 2012, entitled “Mirror that enables user to see a rear view of user by pressing a button”, which is hereby incorporated by reference.

### BACKGROUND OF THE INVENTION

The present invention relates to a hindsight mirror apparatus. Specifically, a mirror which enables users to see a rear image of themselves.

Typically, a mirror enables a user to see a front view of one's self however a mirror fails to allow a user to see exactly how they look from the rear. In addition, a conventional mirror typically does not provide a user with a close-up and a distant view thereof, as desired.

It is desirable to provide a mirror which enables a user to have a complete front view and rear view from a distant or close-up position, as desired.

### SUMMARY OF THE INVENTION

The present invention obviates the above-mentioned issues by providing a hindsight mirror apparatus that includes a mirror device configured to display an image of an object thereon; a monitor unit coupled with the mirror device at a rear thereof and configured to provide the image to the mirror device to be displayed; an image capturing device electrically connected with the monitor unit and configured to capture the image to be displayed, wherein the image to be displayed is a front view and a rear view of the object; and a control mechanism configured to control the image capturing device, the mirror device and the monitor unit, to capture and display the image and to supply power to the hindsight mirror apparatus.

Embodiments of the present invention further provide a method that includes capturing an image of an object; transferring the captured image to a monitor unit for displaying; displaying the image via a mirror device connected with the monitor unit, wherein the image is a front view or a rear view of the object.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a diagram illustrating an operation of a hindsight mirror apparatus that can be implemented within one or more embodiments of the present invention;

FIG. 2 is diagram illustrating another operation of the hindsight mirror apparatus of FIG. 1 that can be implemented according to one or more embodiments; and

FIG. 3 is a flow diagram illustrating a method of displaying an image that can be implemented within one or more embodiments of the present invention.

### DETAILED DESCRIPTION OF THE INVENTION

Embodiments of the present invention enable a user while looking in a first direction (i.e., directly into a mirror device), to view a rear view thereof as desired. The user may view the rear view thereof at a predetermined distance (i.e., close-up or distant) as desired. Therefore, a user may perform a close examination, for example, of a rash, scar, wound, wart, bruise, skin condition, or tattoo without requiring the assistance of another user. According to one or more embodiments, a user may use the hindsight mirror apparatus, to view a complete front view thereof and control the hindsight apparatus to display a complete rear view thereof at a predetermined distance, as desired.

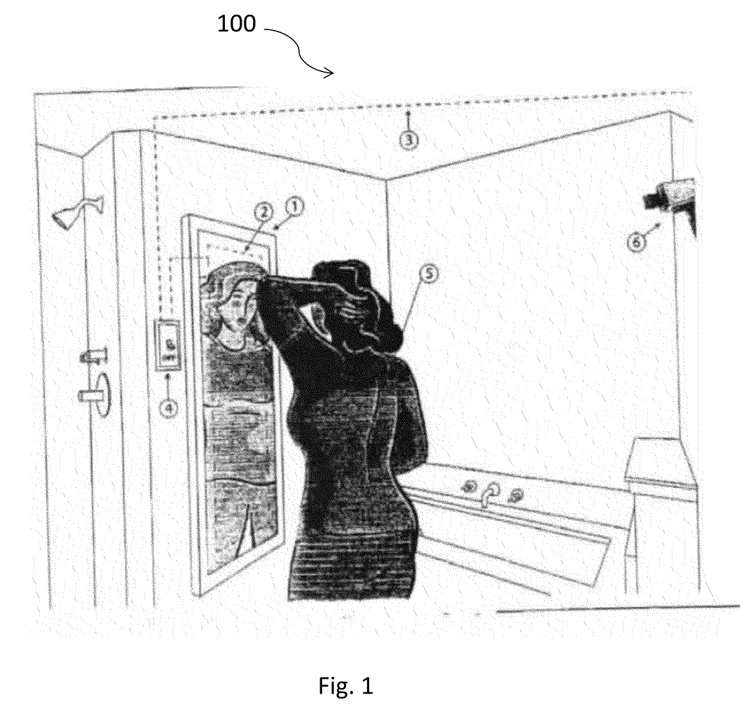

FIG. 1 is a diagram illustrating an operation of a hindsight mirror apparatus that can be implemented within one or more embodiments of the present invention. As shown in FIG. 1, a hindsight mirror apparatus 100 is provided. The hindsight mirror apparatus 100 includes a mirror device 1, a monitor unit 2, a data communication/transmission component 3, a control mechanism 4, an object 5, and an image capturing device 6.

According to one or more embodiments, the mirror device 1 is configured to display an image of the object 5 thereon. The mirror device 1 is formed of a material capable of enabling a user to view a front view of the object 5 (e.g., the user) and to convert to a clear glass to enabling viewing of an image (e.g., a rear view of the object 5) via the monitor unit 2 coupled with the mirror device 1 at a rear thereof and configured to provide the image to the mirror device 1 to be displayed. Although the figures illustrate a user as an object to be displayed, the present invention is not limited to only displaying the user, and may be used for any type of object 5.

According to an embodiment of the present invention, the mirror device 1 is formed of a dielectric material having a thin coating thereon to enable light to pass through freely. The light converts to clear glass when energy radiates from the monitor unit 2 such that the image is displayed (i.e., shown) through the mirror device 1. The light is reflected from its surface to create the mirror effect. The present invention is not limited to any particular type of material of the mirror device 1, and therefore any material suitable for the purpose set forth herein may be implemented. According to one or more embodiments, the mirror device 1 may be formed of a mineral glass coated on one or more sides with an optical interference layer to enable reflection and transparency. Thus, when the monitor unit 2 is off, the mirror device 1 acts as a mirror and when the monitor unit 2 is on the mirror device 1 shows the image displayed on the monitor unit 2.

The monitor unit 2 may be general computer display unit for displaying the image thereon. Since the mirror device 1 is formed of a material to enable light to pass through freely, any image displayed on the monitor unit 2 may be visible to the user from a front of the mirror device 1. The present invention is not limited to any particular type of monitor unit 2 and therefore any suitable monitor unit 2 may be used herein.

According to one or more embodiments, the mirror device 1 and the monitor unit 2 are integrally combined as a single unit. For example, the mirror device 1 may be a coating formed on the monitor unit 2 for providing a mirror effect thereof when desired.

According to one or more embodiments, the image capturing device 6 is electrically connected with the monitor unit 2 via the data communication/transmission component 3. The image capturing device 6 is configured to capture the image to be displayed. The image may be in the form of a still image or a data (e.g., video) stream to be displayed. The image may be a front view and/or a rear view of the object 5. The image capturing device 6 may be a surveillance-type camera or any other type of camera or any type of image capturing device. Further, the image capturing device 6 may be mounted in an opposite location than that of the mirror device 1 and monitor unit 2 in order to capture a rear view of the object 5 when positioned in front of the mirror device 1. The image capturing device 6 may be of any size and mounted in or on a wall structure, or ceiling structure or other hidden location in a direction to capture the image of the object 5. The image capturing device 6 further includes zooming capabilities to zoom in and out for capturing the image at a predetermined distance (close-up or distant), manually or automatically as desired by the user. The predetermined distance is not limited to any particular distance and may vary accordingly.

According to one or more embodiments, a front view and a rear view of the object 5 may be displayed via the monitor unit 2, simultaneously such that the user may be able to see a front view and a rear view of one's self at the same time.

According to one or more embodiments, the data communication/transmission component 3 is formed of a multi-conductor type cable or other transmission medium for transmission of image data signals and other data signals therethrough. The data communication/transmission component 3 is hidden from sight, for example, the data communication/transmission component 3 may be disposed within an interior surface of a wall. The data communication/transmission component 3 further is used to facilitate supply of the power to turn the image capturing device 6 in an on-state and an off-state via the control mechanism 4 and in addition to routing the data signals to the monitor unit 2. According to another embodiment, separate wiring may be used to perform these functions. That is, a first wiring may be used to control the on and off states of the image capturing device 6 or the hindsight mirror apparatus, while a second wiring may be used to route the data signals, or any other suitable wiring may be performed.

The control mechanism 4 is connected with the mirror device 1, the monitor unit 2, and the image capturing device 6 via the data communication/transmission component 3. The control mechanism 4 is configured to control the image capturing device 6, the mirror device 1 and the monitor unit 2, to capture and display the image, and to supply power to the hindsight mirror apparatus 100 via an external power supply (not shown). The external power supply may be the electrical wiring of a building structure (e.g., a house). According to one or more embodiments, the control mechanism 4 may be a switch unit for switching the image capturing device 6 between the on-state and the off-state and for controlling operation of the hindsight mirror apparatus 100. The control mechanism 4 may also control the zoom-in and out functionality of the image capturing device 6. Thus, the control mechanism 4 may control a total operation of the hindsight mirror apparatus 100. According to one or more embodiments, the control mechanism 4 may be of a rotary switch or any other type of switch to allow zooming and focusing functions and turning on and off of the hindsight mirror apparatus via the same control mechanism 4. According to another embodiment of the present invention, a separate remote control unit may be used in place or in addition to the control mechanism 4 to operate the image capturing device 6 and/or all other components of the hindsight mirror apparatus.

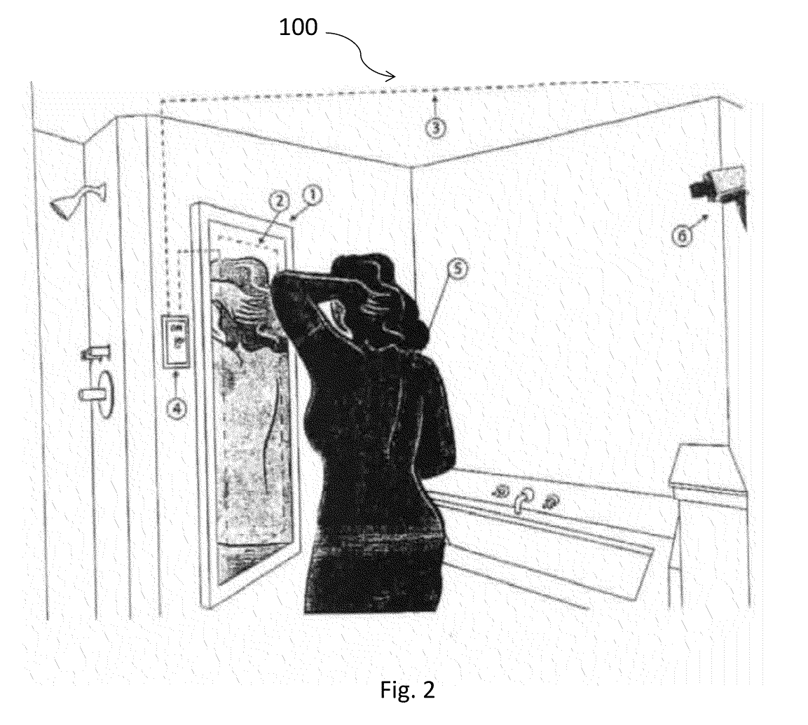

An operation of the hindsight apparatus mirror will now be described below with reference to FIGS. 1 and 2.

As shown in FIG. 1, when the object 5 (e.g., a user) is positioned in front of the mirror unit 1, and is able to view a front view of the object 5 (e.g., oneself) as desired. When a user desires to view a rear view of the object 5 as shown in FIG. 2, the user activates the control mechanism 4 when turns the image capturing device 6 into an on-state. The image capturing device 6 then captures an image of a rear view of the object 5 and transmits associated image data to the monitor unit 2 via the data communication/transmission component 3. When the image is displayed on the monitor unit 2, the light illuminated therefrom penetrates the mirror device 1 such that the image appears visible to the user via the mirror device 1. That is, the activated monitor unit 2 clears a screen of the mirror unit 1 so that the image from the image capturing device 6 can be shown on the screen of the mirror unit 1. The user may manipulate the view of the image via the control mechanism 4, for example. Thus, the user may perform a zoom operation of the view to view the image at a predetermined distance, as desired.

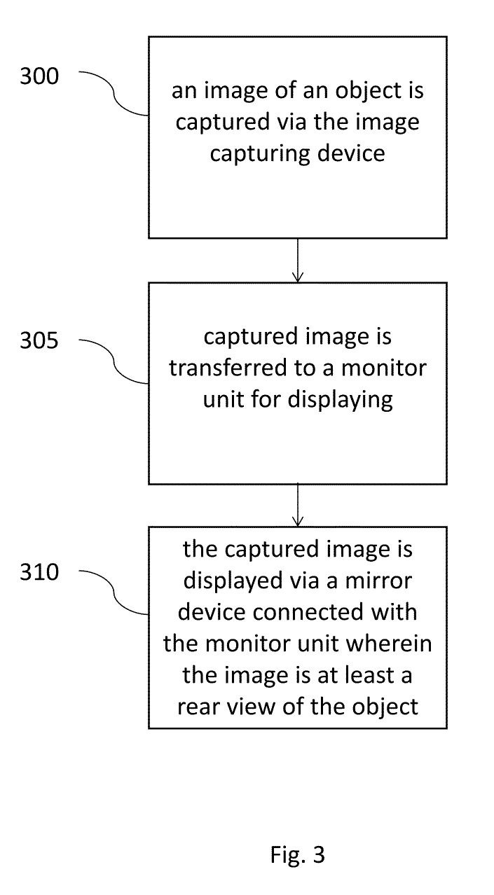

FIG. 3 is a flow diagram illustrating a method of displaying an image that can be implemented within one or more embodiments of the present invention. As shown in FIG. 3, the method begins at operation 300 where an image of an object is captured via the image capturing device. From operation 300 the process continues to operation 305 where the captured image is transferred to a monitor unit for displaying.

From operation 305, the process continues to operation 310 where the captured image is displayed via a mirror device connected with the monitor unit wherein the image is at least a rear view of the object.

Advantages of embodiments of the hindsight mirror apparatus 1 enable a user to closely see a rear view (i.e., a hind view) of the user in order to view for example, hair style, or loss, or color, clothing for tailoring or purchase, or body features such as warts, moles, scars, skin rashes, bruises for medical purposes. Embodiments of the present invention would be ideal for usage in hair salons, barber shops, clothing or department stores, dance studios, fitness centers or personal home use.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A hindsight mirror apparatus comprising:
a mirror device configured to display an image of an object thereon;
a monitor unit coupled with the mirror device at a rear thereof and configured to provide the image to the mirror device to be displayed;
an image capturing device electrically connected with the monitor unit and configured to capture the image to be displayed, wherein the image to be displayed is at least a rear view of the object; and
a control mechanism configured to control the image capturing device, the mirror device and the monitor unit, to capture and display the image, and to supply power to the hindsight mirror apparatus.

2. The apparatus of claim 1, wherein the mirror device is formed of a material for viewing the image therethrough.

3. The apparatus of claim 2, wherein the material is a dielectric material configured to pass light therethrough.

4. The apparatus of claim 3, wherein the dielectric material is a coating formed on the mirror device.

5. The apparatus of claim 4, wherein the mirror device is formed on the monitor unit such that the mirror device and the monitor unit are integrally combined as a single unit.

6. The apparatus of claim 3, wherein the light is reflected from a surface of the mirror device to create a mirror effect.

7. The apparatus of claim 1, wherein the mirror device and the monitor unit are integrally combined as a single unit.

8. The apparatus of claim 1, wherein the image capturing device is electrically connected with the monitor unit via a data communication/transmission component.

9. The apparatus of claim 8, wherein the image capturing device is further configured to capture still images and video data stream to be displayed.

10. The apparatus of claim 9, wherein the image capturing device is further configured to include zooming capabilities to zoom in and out for capturing the image at a predetermined distance manually or automatically as determined by a user.

11. The apparatus of claim 1, wherein a front view and a rear view of the object may be displayed via the monitor unit simultaneously.

12. The apparatus of claim 8, wherein the data communication/transmission component is configured to transmit image data signals of the still images and the video data stream therethrough to the monitor unit and to facilitate supply of the power to turn the image capturing device in an on-state and an off-state via the control mechanism.

13. The apparatus of claim 12, wherein the control mechanism is connected with the mirror device, the monitor unit, the image capturing device via the data communication/transmission component.

14. The apparatus of claim 13, wherein the control mechanism is further configured to control the zooming capability of the image capturing device and total operation of the hindsight mirror apparatus.

15. The apparatus of claim 14, wherein the object is positioned in front of the mirror unit, and the front view of the object is visible via the mirror unit.

16. The apparatus of claim 15, wherein when a user desires to view the rear view of the object, the user activates the control mechanism and the image capturing device is turned to the on-state to capture an image of at least the rear view of the object and transmits associated image data to the monitor unit via the communication component, wherein the image is displayed on the monitor unit and light illuminated therefrom penetrates the mirror device such that the image is visible to the user via the mirror device.

17. A method of displaying an image of an object via a mirror device, comprising:
capturing the image via an image capturing device;
transferring the captured image to a monitor unit for displaying; and
displaying the captured image via a mirror device connected with the monitor unit wherein the image is of at least a rear view of the object.
